(19) United States
(12) Patent Application Publication
(10) Pub. No.: US 2026/0082421 A1
(43) Pub. Date: Mar. 19, 2026

(54) METHOD AND ACCESS POINT FOR SHARING A TRANSMISSION OPPORTUNITY

(71) Applicant: TP-Link Systems Inc., IRVINE, CA (US)

(72) Inventor: Junbin CHEN, Chengdu (CN)

(73) Assignee: TP-Link Systems Inc., IRVINE, CA (US)

(21) Appl. No.: 18/885,548

(22) Filed: Sep. 13, 2024

(51) Int. Cl. H04W 74/0816; H04W 16/10; H04W 72/044

(52) U.S. Cl. CPC H04W 74/0816; H04W 16/10; H04W 72/044

(57) ABSTRACT

This disclosure provides a method and access point (AP) for sharing a transmission opportunity (TXOP). The method includes: determining a bandwidth resource of a frequency band which is not to be used by the first AP for a first time period of the TXOP of the frequency band, and transmitting a signal for announcing the bandwidth resource not to be used by the first AP for the first time period, wherein the signal indicates a delay requirement for one or more second APs to determine whether to contend for the bandwidth resource.

### TECHNICAL FIELD

The present disclosure relates to wireless communication, in particular to a method and access point (AP) for sharing a transmission opportunity (TXOP).

### BACKGROUND

Draft Wi-Fi 7 adopts TXOP Sharing (TXS) technology as a formal media access control (MAC) layer technology, in which an AP (i.e., the sharing AP) is allowed to share its TXOP with STAs (i.e., the shared STAs), and the shared STAs can continuously transmit multiple UL frames to the AP or initiate a peer-to-peer (P2P) transmission to other STAs in the shared TXOP. In this technology, the AP may indicate to a STA that it is sharing TXOP by sending a special multi-user request-to-send (MU-RTS) TXS frame, and the STA replies to the AP by sending a clear to send (CTS) frame, to indicate that it accepts the shared TXOP of the AP.

Currently, it is being discussed to extend the TXS technology among APs. Collaborative time division multiplexing (C-TDMA) among multiple APs may be realized by allowing an AP to share its TXOP with other APs.

### SUMMARY

Based on the above, the present disclosure provides a method and an access point for sharing a transmission opportunity (TXOP).

In an aspect of the present disclosure, the present disclosure provides a method for sharing a transmission opportunity (TXOP) performed by a first access point (AP), comprising: determining a bandwidth resource of a frequency band which is not to be used by the first AP for a first time period of the TXOP of the frequency band, and transmitting a signal for announcing the bandwidth resource not to be used by the first AP for the first time period, wherein the signal indicates a delay requirement for one or more second APs to determine whether to contend for the bandwidth resource.

In yet an aspect of the present disclosure, the present disclosure provides a method for sharing a transmission opportunity (TXOP) performed by a second access point (AP), comprising: receiving a signal for announcing a bandwidth resource not to be used by a first AP transmitting the signal for a first time period of the TXOP, wherein the signal indicates a delay requirement for one or more APs receiving the signal which comprise the second AP to determine whether to contend for the bandwidth resource; and contending for the bandwidth resource in response to a determination that a delay requirement for a data transmission to be transmitted of the second AP satisfies the delay requirement indicated by the signal.

In yet an aspect of the present disclosure, the present disclosure provides a method for sharing a transmission opportunity (TXOP) performed by a first access point (AP), comprising: determining a bandwidth resource of a frequency band which is not to be used by the first AP for a first time period of the TXOP of the frequency band, and transmitting a signal for announcing the bandwidth resource not to be used by the first AP for the first time period, wherein the signal indicates one or more second APs and respective bandwidth resources allocated for the one or more second APs, and wherein the one or more second APs use the respective allocated bandwidth resources to transmit a data transmission.

The present disclosure further provides a first access point (AP) for sharing a transmission opportunity (TXOP), comprising a circuit and a transceiver, configured to perform methods as described according to various embodiments in the disclosure.

The present disclosure further provides a second access point (AP) for sharing a transmission opportunity (TXOP), comprising a circuit and a transceiver, configured to perform methods as described according to various embodiments in the disclosure.

The present disclosure further provides a non-transitory computer readable medium storing instructions, when executed by a processor, causing the processor and a transceiver to perform methods as described according to various embodiments in the disclosure.

The present disclosure further provides an access point comprising means for performing methods as described according to various embodiments in the disclosure.

The present disclosure further provides a computer program product comprising instructions, when executed by a processor causes the processor and a transceiver to perform methods as described according to various embodiments in the disclosure.

### BRIEF DESCRIPTION OF THE DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation to the present disclosure. In the drawings, unless otherwise explicitly indicated, the same reference numerals refer to the same components, steps or elements. In the accompanying drawings,

FIG. 1 shows an example communication system in which the method for sharing a TXOP according to an embodiment of the present disclosure may be applied;

FIG. 2 shows a flow diagram illustrating an example method for sharing a TXOP according to an embodiment of the present disclosure;

FIG. 3A shows a diagram for illustrating an example of a frequency band and a channel according to an embodiment of the present disclosure;

FIG. 3B shows a diagram for illustrating another example of a frequency band and a channel according to an embodiment of the present disclosure;

FIG. 4 shows a flow diagram for further illustrating S202 of determining the bandwidth resource to be shared in FIG. 2 according to an embodiment of the present disclosure;

FIG. 5 is a diagram of an example for illustrating determining the bandwidth resource to be shared according to an embodiment of the present disclosure;

FIG. 6 is a diagram of another example for illustrating determining the bandwidth resource to be shared according to an embodiment of the present disclosure;

FIG. 7 shows a diagram illustrating an example frame for announcing the bandwidth resource to be shared according to an embodiment of the present disclosure;

FIG. 8 shows a flow diagram illustrating an example method for sharing a TXOP according to an embodiment of the present disclosure;

FIG. 9 is a schematic diagram of a communication device, for example an AP, according to an embodiment of the present disclosure;

FIG. 10 shows an example configuration of a communication device, for example an AP, according to an embodiment of the present disclosure; and

FIG. 11 shows an example configuration of a communication device, for example a non-AP or a STA, according to an embodiment of the present disclosure.

### DETAILED DESCRIPTION

The technical solution of the present disclosure will be clearly and completely described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that orientations or positional relationships indicated by terms such as “center”, “upper”, “lower”, “left”, “right”, “vertical”, “horizontal”, “inside” and “outside” are based on orientations or positional relationships shown in the drawings, only for the convenience of describing the present disclosure and simplifying the description, instead of indicating or implying the indicated device or element must have a particular orientation. In addition, terms such as “first”, “second” and “third” are only for descriptive purposes, whereas cannot be understood as indicating or implying relative importance. Likewise, words like “a”, “an” or “the” do not represent a quantity limit, but represent an existence of at least one. Words like “include” or “comprise” mean that an element or an object in front of the said word encompasses those ones listed following the said word and their equivalents, without excluding other elements or objects. Words like “connect” or “link” are not limited to physical or mechanical connections, but may include electrical connections, whether direct or indirect.

In the description of the present disclosure, it should be noted that, unless otherwise explicitly specified and limited, terms such as “mount”, “link” and “connect” should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined with each other as long as no conflicts occurs therebetween. Further, figures are merely for illustration and are simplified for brevity and thus may be not exactly the same as practical implementations. For example, in figures, the processing delay of devices may be omitted.

In the present disclosure, an AP, which may be interchangeably referred to as a wireless access point (WAP), is a communication device that can communicate with a non-AP (e.g., STA) in a WLAN via one or more links and that allows the non-AP to be connected to a wired network. The AP is usually connected to a router (via a wired network) as a standalone device, but it can also be integrated with or employed in the router.

Likewise, in the present disclosure, a non-AP (e.g., a station or terminal, which is interchangeably referred to as an STA) is a communication device that can communicate with an AP via one or more links. The STA may be any device that contains an IEEE 802.11-conformant media access control (MAC) and physical layer (PHY) interface to the wireless medium (WM). For example, an STA may be a laptop, a desktop personal computer (PC), a personal digital assistant (PDA), an access point, or a Wi-Fi phone in a WLAN environment. The STA may be fixed or mobile. In the WLAN environment, the terms “STA”, “terminal”, “wireless terminal”, “user”, “user device”, and “node”are often used interchangeably.

In the present disclosure, a STA in a WLAN may work as an AP at a different occasion, and vice versa. This is because communication devices in the context of IEEE 802.11 (Wi-Fi) technologies may include both STA hardware components and AP hardware components. In this manner, the mode of a communication device may switch between a STA mode and an AP mode, based on actual WLAN conditions and/or requirements. In various embodiments below, a non-AP STA may refer to an STA or terminal in a WLAN that is not implemented as an AP.

As described above, currently, the TXS technology is being extended to be used among APs. In the current TXS technology among APs, it is generally that the sharing AP itself determines which AP to share its TXOP with, and only the sharing of the whole frequency band of the TXOP to one shared AP is supported. Once shared, the sharing AP will not be able to use this TXOP itself during the sharing duration, unless the shared AP signals a TXOP return. Thus, there is need to further improve the TXS technology among APs. In this regard, some ones propose to share a part of the frequency band of the TXOP instead of the whole frequency band of the TXOP, and propose that APs contend for the part of the frequency band of the TXOP, rather than the sharing AP itself determines which AP to share the part of frequency bandwidth.

However, the TXS technology among APs requires further improvements, for further reducing the overall delay of the data transmission and improving the system performance of a communication system comprising several APs. For example, in the above-mentioned TXS technology among APs, when determining the bandwidth resource to be shared, only the bandwidth resource required by the sharing AP and the bandwidth resource required by a data transmission of shared AP candidates which is predicted to be arrived after the beginning of the TXOP are considered, which may not only cause the determined bandwidth resource to be shared to be inexact, but also may cause the data transmission of the sharing AP to be negatively affected. Further, this method strongly depends on the prediction of the bandwidth resource required by the data transmission of shared AP candidates to be arrived after the beginning of the TXOP, and if the sharing AP does not have the capability to do this prediction, this method can not work well. Yet for example, when determining which shared AP candidates to contend for the bandwidth resource to be shared, only the QoS-priority for the data transmission (i.e., the VI traffic is of higher priority than the BE traffic) to be transmitted of the shared AP candidate is considered, which may cause the urgent traffic (e.g., sometimes the BE traffic may have a smaller value of a maximum allowable delay than VI traffic) can not be transmitted timely.

Based on the above, the disclosure provides a method, and a communication device (e.g., AP, such a sharing AP and a shared AP candidate) for sharing a TXOP, which can further improve the TXS technology among APs, for example, with respect to the determination of the bandwidth resource to be shared and the determination of which shared AP candidates to contend for the bandwidth resource to be shared, resulting in reducing the overall delay of the data transmission and improving the system performance of the communication system comprising several APs.

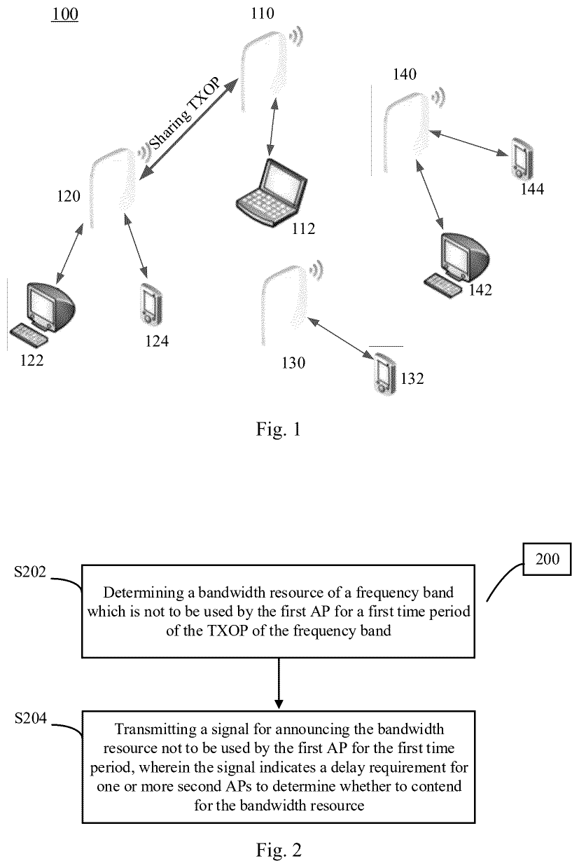

FIG. 1 shows an example communication system 100 in which the method for sharing a TXOP according to an embodiment of the present disclosure may be applied. As shown in FIG. 1, the communication system 100 may be a communication system comprising several APs, AP 110, AP 120, AP 130 and AP 140. Each of AP 110, AP 120, AP 130 and AP 140 can connect to a network (e.g., an internet) (not shown) via wireless or wired connection. Each of APs in the communication system 100 can communicate with one or more STAs, so that the one or more STAs can connect to the network (e.g., the internet). For example, AP 110 can connect to STA 112 which is a laptop, AP 120 can connect to STA 122 and STA 124 which are a desktop personal computer and a mobile phone respectively, AP 130 can connect to STA 132 which is a mobile phone, and AP 140 can connect to STA 142 and STA 144 which are a desktop personal computer and a mobile phone respectively. Further AP 110, AP 120, AP 130 and AP 140 can communicates with each other wirelessly or wired. In the example of communication system 100 shown in FIG. 1, AP 110 can obtain a TXOP of a frequency band, and then AP 110 can share the obtained TXOP with AP 120, so that the AP 110 and AP 120 can share the obtained TXOP.

In this disclosure, an AP (e.g., AP 110) that actively shares its TXOP with another AP(s) may be called a sharing AP (e.g., by transmitting a signal), other APs (i.e., the neighbor APs of the sharing AP, for example, AP 120, AP 130, and AP 140) in the communication system comprising the sharing AP may be called shared AP candidates, and a shared AP candidate (e.g., AP 120) may be called a shared AP after obtaining the TXOP shared by the sharing AP (e.g., by contending). Notably, the communication system 100 shown in FIG. 1 is just an example, rather than a limitation. For example, although FIG. 1 shown four APs, and two APs (AP 110 and AP 120) share a TXOP, the communication system in which the method for sharing a TXOP according to an embodiment of the present disclosure can be applied can comprise more or fewer APs, and more than two APs can share the TXOP, e.g., AP 110 can share its TXOP with AP 120 and AP 130. Further, in the disclosure, the sharing AP and the first AP can be used interchangeably, and the shared AP candidate and the second AP can be used interchangeably.

FIG. 2 shows a flow diagram illustrating an example method 200 for sharing a TXOP according to an embodiment of the present disclosure. This method 200 may be performed by a communication device, e.g., an AP (i.e., a sharing AP, which may also referred to as a first AP below). Exemplarily, The TXOP may be a TXOP of a specific frequency band obtained by the sharing AP based on a backoff procedure. In an embodiment, the method 200 for sharing the TXOP may be performed by the sharing AP unconditionally. In another embodiment, after obtaining the TXOP of the frequency band, the method 200 for sharing the TXOP may be performed by the sharing AP, if the traffic of the sharing AP to be transmitted is not a delay-sensitive traffic, or the bandwidth resource required by the sharing AP is smaller than the frequency band.

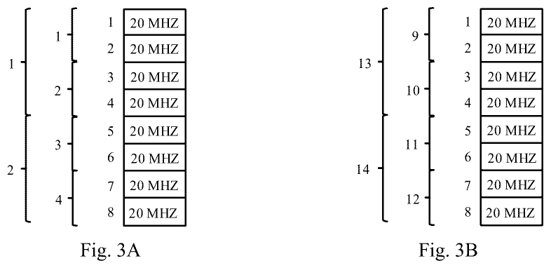

In this disclosure, the frequency band is a specific frequency range of a radio wave, which may be continuous (e.g., a frequency band comprising a single continuous 80 MHz) or un-continuous (e.g., a frequency band comprising a single continuous 80 MHz and another continuous 80 MHz, but the two 80 MHz being not continuous) and may be divided into several channels, e.g., as shown in FIGS. 3A and 3B. FIG. 3A shows a diagram for illustrating an example of a frequency band and a channel according to an embodiment of the present disclosure. In FIG. 3A, a frequency band of 160 MHz (i.e., the bandwidth of the frequency band is 160 MHz) is shown, and it may be divided into 8 channels of 20 MHz which are indexed as channel 1-8, 4 channels of 40 MHz which are indexed as channel 1-4, and 2 channels of 80 MHz which are indexed channel 1-2, etc. FIG. 3B shows a diagram for illustrating another example of a frequency band and a channel according to an embodiment of the present disclosure. In FIG. 3B, a frequency band of 160 MHz is shown, and it may be divided into 8 channels of 20 MHz which are indexed as channel 1-8, 4 channels of 40 MHz which are indexed as channel 9-12, and 2 channels of 80 MHz which are indexed channel 13-14, etc.

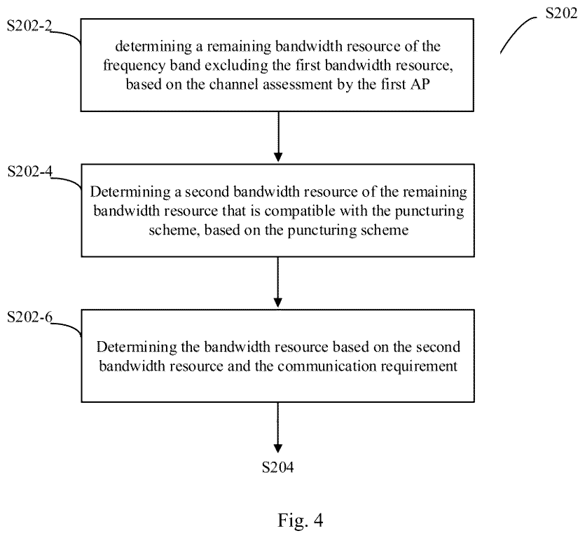

As shown in FIG. 2, the method 200 for sharing the TXOP starts at block S202. At block S202, a bandwidth resource (i.e., a set of resources in frequency domain, which may be referred to as the bandwidth resource to be shared below) of a frequency band (e.g., the frequency band of 160 MHz shown in FIGS. 3A and 3B) which is not to be used by the sharing AP (i.e., the first AP, for example AP 110 shown in FIG. 1) for a first time period of the TXOP of the frequency band is determined. The first time period can be determined based on the length of the TXOP, e.g., it is the half of the length of the TXOP. Of course, The first time period can be determined based on other factors, e.g., the estimated time for transmitting the traffic of the shared AP candidates. In an embodiment, the bandwidth resource may be determined based on at least one of a bandwidth resource (i.e., a first bandwidth resource) required by the sharing AP, a channel assessment by the sharing AP and a communication requirement associated with one or more shared AP candidates (i.e., one or more two second APs, for example, AP 120, AP 130 and AP 140 shown in FIG. 1). In another embodiment, in addition to the bandwidth resource required by the first AP, the channel assessment by the sharing AP and the communication requirement associated with the one or more second APs, the determination of the bandwidth resource may be further based on a puncturing scheme associated with the frequency band, which will be described in connection with FIG. 4 in detail below. In this manner, it may be ensured that the sharing AP can use the remaining bandwidth of the frequency band excluding the bandwidth resource to be shared by preamble puncturing, so that the data transmission of the sharing AP will not be affected adversely. Further, the bandwidth resource to be shared can be an integer multiple of 20 MHz, e.g., 20 MHz, 40 MHz, 80 MHz, and the like.

Exemplarily, the communication requirement associated with the one or more second APs can comprise at least one of: a requirement that the bandwidth resource covers a maximum number of the primary channel of APs among the one or more second APs, a bandwidth resource requirement of the one or more second APs or a delay requirement for the data transmission of the one or more second APs. Exemplarily, the bandwidth resource requirement of the one or more second APs may be determined based on prior knowledge of the one or more second APs. For example, in an embodiment, the determination of the bandwidth resource requirement of the one or more second APs may be based on a data amount of the one or more second APs which is predicted to be arrived after the beginning of the TXOP. In another embodiment, the determination of the bandwidth resource requirement of the one or more second APs may be based on the data amount of the one or more second APs which is predicted to be arrived after the beginning of the TXOP and/or a data amount of the one or more second APs buffered before beginning of the TXOP. In such a way, the bandwidth resource of the one or more second APs required during the TXOP may be determined more exactly. In this disclosure, the primary channel is the channel over which the AP transmits both the beacon messages and data messages. More specifically, the primary channel is the common channel of operation for all stations (STAs) that are members of the basic service set (BSS). For example, in a 20 MHz, 40 MHz, 80 MHz, 160 MHz or 80+80 MHz BSS the primary channel is a primary 20 MHz channel.

FIG. 4 shows a flow diagram for further illustrating S202 of determining the bandwidth resource to be shared in FIG. 2 according to an embodiment of the present disclosure, in which, the bandwidth resource is determined based on at least one of the first bandwidth resource required by the first AP, the channel assessment by the first AP, the puncturing scheme associated with the frequency band, and the communication requirement associated with the one or more second APs. At block S202-2, a remaining bandwidth resource(s) of the frequency band excluding the first bandwidth resource required by the first AP may be determined, based on the channel assessment by the first AP. Exemplarily, determining the remaining bandwidth resource can comprise determining a bandwidth of the remaining bandwidth resource based on a bandwidth of the frequency band and a bandwidth of the first bandwidth resource required by the first AP, and determining the location of the remaining bandwidth resource within the frequency band based on the channel assessment by the first AP. Exemplarily, the channel assessment by the first AP can comprise the assessment of the busy degree of each channel included in the frequency band and/or whether the primary channel of the first AP can be shared. In this case, the location of the remaining bandwidth resource within the frequency band can be determined based on the assessment of the busy degree of each channel included in the frequency band and/or whether the primary channel of the first AP can be shared. For example, the location of the remaining bandwidth resource can be determined as comprising the busiest channel included in the frequency band, but not comprising the primary channel of the first AP. In another example, the location of the remaining bandwidth resource can be determined as comprising the busiest channel and the primary channel of the first AP if the first AP and the one or more second APs both support the dynamic sub-channel operating (DSO) function, in which the AP or STA can temporarily and dynamically switch to a secondary channel to access and operate without accessing the primary channel.

At block S202-4, a bandwidth resource(s) (i.e., a second bandwidth resource) of the remaining bandwidth resource that is available to be punctured is determined, based on the puncturing scheme. That is, the first AP determines the bandwidth resource which is capable of being punctured within the remaining bandwidth resource as the second bandwidth resource which is possible to be shared. In a case where a plurality of puncturing schemes are supported, a plurality of possible second bandwidth resources may be determined.

At block S202-6, the bandwidth resource (i.e., the bandwidth resource which is actually to be shared) is determined based on the second bandwidth resource and the communication requirement associated with the one or more second APs. Exemplarily, in a case where a plurality of puncturing schemes are supported, and accordingly a plurality of possible second bandwidth resources are determined, the bandwidth resource to be shared may be determined by selecting a possible second bandwidth resource from the plurality of possible second bandwidth resources based on the communication requirement associated with the one or more second APs, and determining the bandwidth resource to be shared (which may be a part or all of the selected possible second bandwidth resource) within the selected possible second bandwidth resource based on the communication requirement associated with the one or more second APs. In addition, in the process of determining the bandwidth resource to be shared, a priority may be assigned to the bandwidth resource that has not been shared before, for the overall resource efficiency of frequency band.

After determining the bandwidth resource to be shared, the said bandwidth resource can be announced to be not used by the first AP, so that it can be used by one or more second APs. Then, the sharing AP can use the remaining bandwidth resource of the frequency band excluding the bandwidth resource to be shared, which may be the bandwidth resource with punch(es). If it is determined that there is no bandwidth resource satisfying the related bandwidth resource determination conditions (e.g., the first bandwidth resource required by the first AP, the channel assessment by the first AP, the puncturing scheme associated with the frequency band, or the communication requirement associated with the one or more second APs as described above), it is determined that no bandwidth resource to be shared, and the method for sharing the TXOP can end. Notably, it is understood that the method for determining the bandwidth resource to be shared as shown in FIG. 4 is merely an example, rather than a limitation. For example, the order of steps of the method shown in FIG. 4 can change. For example, a bandwidth resource available to be punched can be determined firstly, and then the bandwidth resource to be shared within the bandwidth resource available to be punched is determined based on other factors, for example, the channel assessment by the first AP etc. For another example, the bandwidth resource to be shared can be determined based on any one or more of the first bandwidth resource required by the first AP, the channel assessment by the first AP, the puncturing scheme associated with the frequency band, or the communication requirement associated with the one or more second APs, rather than all of them.

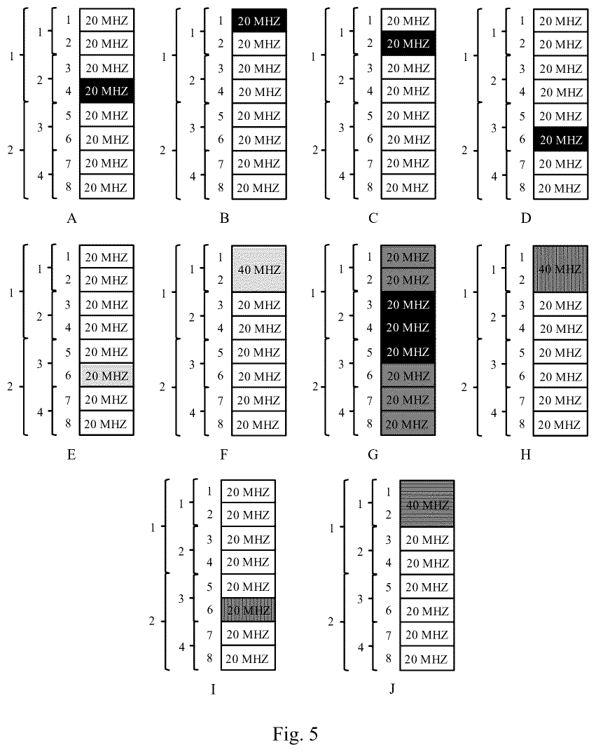

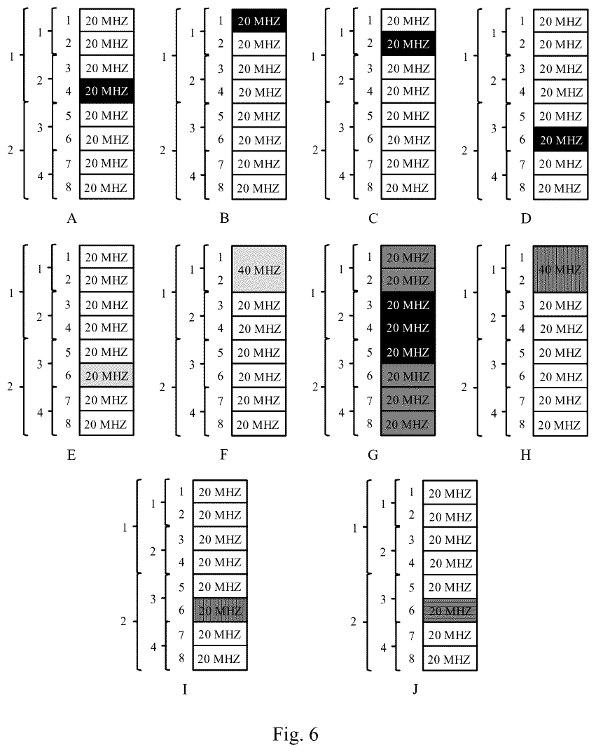

In order to better understand the method for determining the bandwidth resource to be shared shown in FIG. 4, this disclosure will describe two examples in connection with FIGS. 5 and 6.

In the example of FIG. 5, it is assumed that the frequency band of the TXOP obtained by the first AP represented as AP 1 (i.e., the first AP) is 160 MHz, the frequency band is divided into 8 channels of 20 MHz which are indexed as channels 1-8, 4 channels of 40 MHz which are indexed as channel 1-4, and 2 channels of 80 MHz which are indexed channel 1-2. The primary channel of the first AP (i.e., AP 1) is channel 4 of 20 MHz which is shown as the solid black block in diagram A of FIG. 5; the bandwidth resource required by the AP1 is 60 MHz; it is determined that the channel 2 of 20 MHz is the busiest channel and the primary channel of the first AP can not be used as the bandwidth resource to be shared after assessing by the first AP. There are three second APs (i.e., three shared AP candidates) represented as AP 2, AP 3, and AP 4, whose primary channels are channel 1, 2 and 6 of 20 MHz, shown as the solid black block in diagrams B-D of FIG. 5, respectively. A total of two puncturing schemes, i.e., the puncturing scheme I of 20 MHz and the puncturing scheme II of 40 MHz are supported by the frequency band of 160 MHz, shown as solid light grey block in diagrams E and F of FIG. 5 and only one puncturing scheme is supported per puncturing. The communication requirement associated with the three second APs is a requirement that the bandwidth resource covers primary channels of a maximum number of APs among the three second APs.

Firstly, based on the primary channel of the AP 1 (i.e., the sharing AP) being channel 4 of 20 MHz, the bandwidth resource required by the AP1 being 60 MHz, the channel 2 of 20 MHz is the busiest channel, and the primary channel of the first AP can not be used as the bandwidth resource to be shared, it may be determined that the remaining bandwidth resource of the frequency band of 160 MHz excluding the bandwidth resource required by the AP 1 is 100 MHz which is shown as the solid dark grey block in diagram G of FIG. 5. Thereafter, based on the remaining bandwidth resource as shown in diagram G of FIG. 5, two supported puncturing schemes shown in diagrams E and F of FIG. 5 and only one puncturing scheme is supported per puncturing, it may be determined that the possible bandwidth resource to be shared is 40 MHz which is shown as the block of solid dark grey and vertical lines in diagram H of FIG. 5 or 20 MHz which is shown as the block of solid dark grey and vertical lines in diagram I of FIG. 5. That is, the bandwidth resource of the remaining bandwidth resource that can be punched may be determined as the possible bandwidth resource to be shared.

Then, based on the possible bandwidth resources to be shared as shown in diagrams H and I of FIG. 5 and the communication requirement of the one or more second APs (e.g., the requirement that the bandwidth resource covers the primary channels of the maximum number of AP among the three APs), it can be determined that the possible bandwidth resource of 40 MHz to be shared as shown in diagram H of FIG. 5 can cover the primary channels of AP 2 and AP 3, and the possible bandwidth resource of 20 MHz to be shared as shown in diagram I of FIG. 5 can only cover the primary channel of AP 4. Accordingly, it can be determined that in the example of FIG. 5, the bandwidth resource of 40 MHz which is shown as the block of solid dark grey and horizontal lines in diagram J of FIG. 5 (i.e., the bandwidth resource shown in diagram H of FIG. 5) is the actual bandwidth resource which is determined to be shared, since the number of the second APs whose primary channels are covered by the bandwidth resource shown in diagram H of FIG. 5 is 2, which is bigger than that is covered by the bandwidth resource shown in diagram I of FIG. 5. Accordingly, the bandwidth resource of 120 MHz which is shown in white in diagram J of FIG. 5 can be used by AP1 (i.e., the sharing AP).

FIG. 6 is a diagram of another example for illustrating determining the bandwidth resource to be shared according to an embodiment of the present disclosure. In the example of FIG. 6, the assumptions are the same as those in the example of FIG. 5 with an exception that the communication requirement of the one or more second APs is a bandwidth resource requirement of the one or more second APs, rather than the requirement that the bandwidth resource covers the primary channels of the maximum number of AP among the one or more second APs in the example of FIG. 5. In this example, it is further assumed that there is no bandwidth resource requirement of the AP 2 and AP 3, the bandwidth resource requirement of the AP 4 is 20 MHz and AP 4 can not use the bandwidth resource not comprising its primary channel.

In the example of FIG. 6, the determination processes before determining the bandwidth resource to be shared based on the second bandwidth resource and the communication requirement associated with the one or more second APs are the same as those in the example of FIG. 5, as shown in diagrams A-I of FIG. 6. In the process of determining the bandwidth resource to be shared based on the second bandwidth resource (i.e., the block of solid dark grey and vertical lines shown in diagrams H and I in FIG. 6) and the communication requirement associated with the one or more second APs, based on the communication requirement of the one or more second APs is the bandwidth resource requirement of the one or more second APs, and there is no bandwidth resource requirement of the AP 2 and AP 3, the bandwidth resource requirement of the AP 4 is 20 MHz and AP 4 can not use the bandwidth resource not comprising its primary channel, it may be determined that in the example of FIG. 6, the bandwidth resource of 20 MHz which is shown as the block of solid dark grey and horizontal lines in diagram J of FIG. 6 (i.e., the bandwidth resource shown in diagram I of FIG. 6) is the actual bandwidth resource which is determined to be shared, since only AP 4 require the bandwidth resource for data transmission, bandwidth resource shown in diagram I of FIG. 6 can be used for the data transmission of the AP 4, and the bandwidth resource shown in diagram H of FIG. 5 can not be used for the data transmission of the AP 4. Similarly, the bandwidth resource of 140 MHz which is shown in white in diagram J of FIG. 6 can be used by AP1 (i.e., the sharing AP), which has a punch of 20 MHz.

Notably, it is understood that the examples described above in connection with FIGS. 5 and 6 are merely examples rather than limitations. For example, although in the examples of FIGS. 5 and 6, merely three second APs are illustrated, the primary channel of the first AP (i.e., the sharing AP) and the primary channel of each second AP (i.e., each shared AP candidate) both are the channel of 20 MHz, and only one puncturing scheme is supported per puncturing, it is known these are merely example, rather than limitations. For example, the number of the shared AP candidates may be less or more than three, the primary channel of the sharing AP and/or the primary channel of each shared AP candidate may be a channel of another bandwidth (e.g., 40 MHz, 80 MHz etc.), and more than one puncturing scheme may be supported per puncturing.

Returning to FIG. 2, at block S204, a signal (e.g., a frame) (which may be referred to as an announcing signal below) for announcing the bandwidth resource not to be used by the first AP for the first time period is transmitted. The signal indicates a delay requirement for one or more second APs to determine whether to contend for the bandwidth resource, for example, by a filed. Accordingly, rather than all the one or more second APs receiving the signal, only APs of the one or more second APs having a data transmission with a delay requirement satisfying the delay requirement indicated by the announcing signal can contend for the bandwidth resource announced to be shared. In this manner, it may be guaranteed that only APs each having the data transmission with the delay requirement satisfying the delay requirement indicated by the announcing signal can contend for bandwidth resource announced to be shared, thereby facilitating the timely transmission of the data transmission satisfying the delay requirement indicated by the announcing signal.

Exemplarily, the delay requirement for one or more second APs to determine whether to contend for the bandwidth resource may be set by the first AP based on the delay requirement of the data transmission to be transmitted of the one or more second APs. Alternatively, the delay requirement for one or more second APs to determine whether to contend for the bandwidth resource may be set based on other factors, e.g., a factor specified by the user. The delay requirement of the data transmission to be transmitted of a second AP (i.e., a shared AP candidate) may be any delay requirement related to the data transmission and may be dependent on the quality of service (QoS) expectation of the data transmission to be transmitted. For example, it can be a requirement related to an amount of time (e.g., a maximum allowable amount of time in microseconds) between the time marking the arrival of the data (e.g., MAC service data unit (MSDU)) at the local MAC sublayer from the local MAC service access point (MAC-SAP) and the time starting of the transmission of the data. Additionally or alternatively, it can be a requirement related to an amount of time (e.g., a maximum allowable amount of time in microseconds) between the time marking the arrival of the data at the local MAC sublayer from the local MAC-SAP and the time of completion of the successful transmission or retransmission of the data to the destination. The completion of the data transmission may include the relevant acknowledgment frame transmission time, if present.

Notably, there may be a situation that there is only one second AP, i.e., only one shared AP candidate. In this case, although it may be unnecessary that the announcing signal indicates the above delay requirement since there is no contending, the announcing signal can still indicate the delay requirement. In this case, the delay requirement may be indicated as a predefined value, e.g., setting all bits of the filed for indicating the delay requirement to 1, which indicates that there is only one shared AP candidate. Accordingly, the AP receiving the announcing signal which indicates the delay requirement of the predefined value can use the bandwidth resource announced to be shared without contending. In this manner, processes related to sharing the TXOP can be the same in both a situation that there are more than one shared AP candidates and a situation that there is only one shared AP candidate, simplifying the processes related to sharing the TXOP of the sharing AP and the shared AP candidates. Of course, in a case where there is only one shared AP candidate, the announcing signal may not indicate the delay requirement for the shared AP candidate to determine whether to contend for the bandwidth resource to be shared.

Exemplarily, the bandwidth resource to be shared may be announced by indicating information of the bandwidth resource in the announcing signal. In an embodiment, the information of the bandwidth resource may be indicated as a physical frequency range thereof. In another embodiment, the information of the bandwidth resource may be indicated as the bandwidth of the bandwidth resource and the channel number of channels included in the bandwidth resource. The combination of the bandwidth of the bandwidth resource and the channel number of channels included in the bandwidth resource can identify the physical frequency range of bandwidth resource together, since respective combination of the bandwidth of the bandwidth resource and the channel number of channels included in the bandwidth resource correspond to respective physical frequency range of bandwidth resource.

In addition, announcing the bandwidth resource may be carried out by indicating the bandwidth resource as a whole in the announcing signal. Alternatively, the bandwidth resource may be divided into multiple bandwidth units (BWUs) to announce. For example, in the example shown in diagram J of FIG. 5, the bandwidth resource of 40 MHz to be shared may be divided into two BWUs. BWU 1 corresponds to channel 1 of 20 MHz and BWU 2 corresponds to channel 2 of 20 MHz. In this case, the bandwidth resource of 40 MHz may be indicated by indicating BWU 1 through the bandwidth of 20 MHz and the channel number of 1, and indicating BWU 2 through the bandwidth of 20 MHz and the channel number of 2. Further, in a case where the bandwidth of each of BWUs is the same, the bandwidth resource may be indicated by indicating one bandwidth and respective channel numbers, rather than indicating the bandwidth of each BWU and the corresponding channel number. For example, still in the example of the bandwidth resource of 40 MHz to be shared as shown in diagram J of FIG. 5 which is divided into two BWUs, the bandwidth resource of 40 MHz may be indicated by one bandwidth of 20 MHz, and channel numbers of 1 and 2, for further reducing the bits for indicating the bandwidth resource to be shared. In addition, in a case of 3B, it is possible to indicate the BWU by only the channel number.

Regarding the delay requirement indicated by the announcing signal, in an embodiment, the delay requirement can comprise a delay limit, which indicates a maximum allowable delay for a data transmission to be transmitted of an AP(s) available to contend for the bandwidth resource among the one or more second APs. The maximum allowable delay can be the maximum allowable amount of time between the time marking the arrival of the data at the local MAC sublayer from the local MAC-SAP and the time starting of the transmission of the data, or the maximum allowable amount of time between the time marking the arrival of the data at the local MAC sublayer from the local MAC-SAP and the time of completion of the successful transmission or retransmission of the data to the destination, as described above. In this case, only shared AP candidates each having the data transmission with the maximum allowable delay lower than the delay limit are able to contend for the bandwidth resource. In this manner, it may be guaranteed that only shared AP candidates with urgent traffic (i.e., the traffic with a small value of the maximum allowable delay) can contend for the bandwidth resource announced to be shared, thereby achieving the timely transmission of the urgent traffic. Of course, the delay requirement may be defined in other manners, for example defined by a delay range.

In addition, the announcing signal can further indicates the first time period and/or a priority requirement for the one or more second APs to determine whether to contend for the bandwidth resource. In this case, the data transmission of APs among the one or second APs which can contend for the bandwidth resource not only need to satisfy the delay requirement indicated by the announcing signal, but also need to satisfy the priority requirement indicated by the announcing signal. That is, only shared AP candidates each having a data transmission with a delay requirement satisfying the delay requirement indicated by the announcing signal and a priority satisfying the priority requirement indicated by the announcing signal are able to contend for the bandwidth resource. In this manner, it can be guaranteed that only shared AP candidates with urgent and high-priority traffic can contend for bandwidth resource announced to be shared, thereby achieving the timely transmission of the urgent and high-priority traffic. Notably, in a case where the signal for announcing the bandwidth resource to be shared does not indicate the first time period, the first time period may be a default time period, e.g., half of the TXOP.

In addition, the method for sharing the TXOP according to an embodiment of the present disclosure can further comprise the step of determining an AP which is able to use the bandwidth resource to be shared for a second time period of the TXOP (i.e., the contention-free duration) without contending. The second time period may be shorter than or equal to the first time period. In this case, the signal for announcing the bandwidth resource to be shared can further indicate the determined AP and the second time period. When receiving the signal indicating the determined AP and the second time period, the shared AP candidate can determine whether it is the determined AP indicated by the announcing signal, and use the bandwidth resource to be shared without contending during the second time period, in response to determining that it is the determined AP. Upon the second time period ends, if there is a remaining of the first time period, one or more second APs (comprising the determined AP or not comprising the determined AP) can contend that the bandwidth resource to be shared that is used by the determined AP without contending during the second time period.

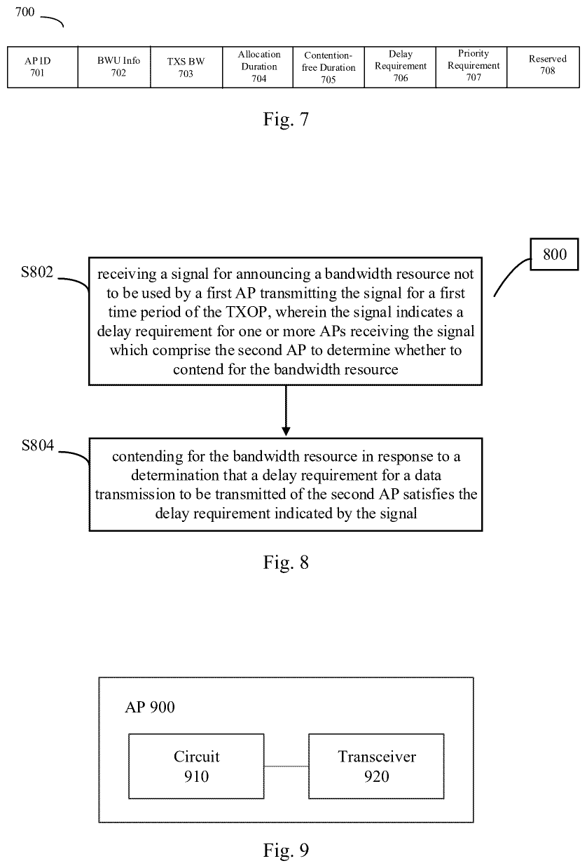

FIG. 7 shows a diagram illustrating an example frame 700 for announcing the bandwidth resource to be shared according to an embodiment of the present disclosure,. The example frame 700 shown in FIG. 7 corresponds to a single BWU. If the bandwidth resource to be shared is not divided into a plurality of BWUs, only one frame 700 is carried in the announcing signal, as a part or all of the payload of the announcing signal. If the bandwidth resource to be shared is divided into a plurality of BWUs, a plurality of frames 700 are carried in the announcing signal. Each of the plurality of frames 700 corresponds to each of the plurality of BWUs. Information of the plurality of frames 700 can be the same or different, depending on the corresponding BWU or other requirement of the first AP and/or the one or more second APs. For example, for a frame 700 corresponding to BWU 1 with 20M, the field of TXS BW 703 can indicate 20 MHZ, and for another frame 700 corresponding to BWU 2 with 40M, the field of TXS BW 703 can indicate 40 MHZ.

As shown in FIG. 7, the frame 700 can comprise fields of AP ID 701, BWU Info 702, TXS BW 703, allocation duration 704, contention-free duration 705, delay requirement 706, priority requirement 707 and reserved 708. The field of AP ID 701 can indicate the ID number of the AP which can use the bandwidth resource to be shared during the second time period (i.e., the contention-free duration indicated by the field of contention-free duration 705) without contending. The field of the BWU Info 703 can indicate the channel number of the BWU. The field of the TXS BW 704 can indicate the bandwidth of the BWU. The field of allocation duration 704 can indicate the first time period as described above, during which the one or more second APs can use the bandwidth resource to be shared with or without contending. The field of contention-free duration 705 can indicate the second time period as described above which may be the first time period of the time period indicated by the field of allocation duration 704, during which the AP indicated by the field of AP ID 701 can use the bandwidth resource of the corresponding BWU (e.g., the bandwidth resource determined by the fields of BWU Info 702 and TXS BW 703). The field of delay requirement 706 can indicate the delay requirement for one or more second APs to determine whether to contend for the bandwidth resource as described above, and the field of priority requirement 707 can indicate the priority requirement for one or more second APs to determine whether to contend for the bandwidth resource as described above, which are not repeated here for brevity. The field of reserved 708 is reserved.

When the value of AP ID 701 is a first default value (e.g., 0) and/or the value of contention-free duration 705 is a second default (e.g., 0), it is indicated that there is no AP that can use the bandwidth resource of the corresponding BWU without contending. When the value of AP ID 701 is not the first default value (i.e., it is an ID number of a second AP) and the value of contention-free duration 705 is not the second default, it is indicated that the second AP corresponding to ID number indicated by AP ID 701 can use the bandwidth resource of the corresponding BWU without contending for a time period indicated by the field of the contention-free duration 705.

In practice, the signal for announcing the bandwidth resource to be shared may be a trigger frame (TF), e.g., a TF based on the current TF (e.g., an EHT TF). For example, adding one or more example frame 700 shown in FIG. 7 to the current TF to form the final frame for announcing the bandwidth resource to be shared. Of course, the signal for announcing the bandwidth resource to be shared may be a different frame from the current TF. Further, it should be understood that the frame shown in FIG. 7 is merely an example, rather than a limitation. In the disclosure, the frame for announcing the bandwidth resource to be shared may include more or fewer fields than those shown in FIG. 7. For example, the frame for announcing the bandwidth resource to be shared may not comprise the fields of AP ID 701, and contention-free duration 705, which indicates the corresponding BWU can not be used by a UE without contending. Further, the order of fields contained in the frame can be different from that shown in FIG. 7.

After the first time period (e.g., the time period indicated by the field of allocation duration 704) ends, the sharing AP can automatically reclaim the bandwidth resource announced in the announcing signal for its own use. Thereafter, the sharing AP can announce a new bandwidth resource (which may be the same as or different from that announced in the previous announcing signal) again if the obtained TXOP does not end. In an embodiment, the new bandwidth resource announced to be shared may be different from that announced in the previous announcing signal, so that shared AP candidates of different primary channels can use the new bandwidth resource announced to be shared.

Additionally, in an embodiment, the sharing AP can reclaim the bandwidth resource to be shared for its usage, in response to a determination that the bandwidth resource is not used by the one or more second APs for a third time period, before the expiration of the first time period. The third time period is shorter than the first time period. In this way, the data transmission of the sharing AP may be facilitated. Thereafter, the sharing AP can announce a bandwidth resource located in another location of the frequency band, so that the AP on another primary channel can use the new bandwidth resource announced to be shared.

Additionally or alternatively, rather than the shared AP candidates actively contending for the bandwidth resource, the sharing AP may schedule (i.e., allocate) bandwidth resources for some or all shared AP candidates. For example, the sharing AP may indicate a plurality of APs and bandwidth resources allocated for the respective plurality of APs in the announcing signal, and accordingly the respective shared AP candidates may perform the signal transmission (e.g., the data transmission) based on the respective bandwidth resources indicated by the announcing signal. Exemplarily, in a case of reusing the frame 700 shown FIG. 7, a BWU can be indicated as a BWU allocated for an AP indicated by the field of AP ID and thus unavailable to be contended by other APs, by setting the value of the field of allocation duration 704 in FIG. 7 to be the same as that of the field of content-free duration 705 in FIG. 7, or setting the field of allocation duration 704 to 0 but the field of content-free duration 705 is not 0.

To carry out the bandwidth resource scheduling of the sharing AP, the sharing AP can perform a query plan. For example, the sharing AP can query the traffic requirement of one or more neighbor APs. Then the sharing AP can actively perform the scheduling based on the queried traffic requirement of the one or more neighbor APs.

In the above disclosure, the method for sharing the TXOP performed by the first AP (i.e., the sharing AP) is described in connection with FIGS. 1-7. In the following, the method for sharing the TXOP performed by the second AP (i.e., the shared AP candidate) will be described in connection with FIG. 8.

FIG. 8 shows a flow diagram illustrating an example method 800 for sharing a TXOP according to an embodiment of the present disclosure. As shown in FIG. 8, the method 800 for sharing the TXOP starts at block S802. At block S802, a signal for announcing a bandwidth resource not to be used by a first AP transmitting the signal for a first time period of the TXOP is received. The signal indicates a delay requirement for one or more APs receiving the signal which comprise the second AP to determine whether to contend for the bandwidth resource. The signal, and the determination of the bandwidth resource are the same as those described above in connection with FIGS. 1-7, which are not repeated here for brevity.

At block S804, contending for the bandwidth resource is performed in response to a determination that a delay requirement for a data transmission to be transmitted of the second AP satisfies the delay requirement indicated by the received signal. For example, if the delay requirement indicated by the announcing signal comprises a delay limit, the second AP (i.e., the shared AP candidate) can contend for the bandwidth resource in response to a determination that a maximum allowable delay for the data transmission to be transmitted of the second AP is lower than the delay limit. In this case, if the second AP determines that the maximum allowable delay of its data transmission to be transmitted is higher than the delay limit, the second AP does not contend for the bandwidth resource.

Additionally, after receiving the announcing signal, the second AP may determine whether its network allocation vector (NAV) timer associated with the frequency band comprising the bandwidth resource to be shared has been set due to a signal transmitted by the first AP. Exemplarily, the setting of the NAV timer may be done by receiving a signal (e.g., a CTS-to-self or RTS signal) transmitted by another AP. The AP setting the NAV timer can not use the frequency band associated with the set NAV timer for a duration, since another AP would use the this frequency band for the duration. In this case, whether the NAV timer of the second AP has been set due to the signal transmitted by the first AP may be determined based on determining whether the NAV timer of the second AP has been set due to receiving a signal from the first AP. If it is determined that the NAV timer associated with the frequency band comprising the bandwidth resource to be shared of the second AP has been set due to the signal transmitted by the first AP, the second AP can perform the step S804; otherwise, the second AP does not perform the step S804, since the frequency band comprising the bandwidth resource to be shared is being used by another AP (i.e., a third AP which is different from the first AP).

Exemplarily, contending for the bandwidth resource to be shared can be based on a backoff procedure. In an embodiment, the backoff procedure may be the existing backoff procedure, in which an initial value of a backoff counter of the backoff procedure is usually a numerical value randomly selected from a fixed range of numerical value (e.g., 0 to CW, CW is the contention window and is fixed). In another embodiment, the backoff procedure may be based on the delay requirement indicated by the announcing signal and/or the delay requirement for the data transmission to be transmitted of the second AP receiving the announcing signal. Specifically, in an embodiment, the backoff procedure based on the delay requirement indicated by the announcing signal and/or the delay requirement for the data transmission to be transmitted can comprise setting the initial value of the backoff counter of the backoff procedure based on the delay requirement indicated by the announcing signal and/or the delay requirement of the data transmission to be transmitted. Exemplarily, the initial value of the backoff counter of the backoff procedure may be set based on a principle that the stricter the delay requirement indicated by the announcing signal is (e.g., the smaller the value of delay requirement is), the smaller the initial value of the backoff counter is, and/or the stricter the delay requirement for the data transmission to be transmitted is (e.g., the smaller the maximum allowable delay of the data transmission to be transmitted is), the smaller the initial value of the backoff counter is.

Additionally or alternatively, in another embodiment, the backoff procedure based on the delay requirement indicated by the announcing signal and/or the delay requirement of the data transmission to be transmitted can comprise that a value subtracted from the backoff counter every time (i.e., the backoff step) when it is detected that the channel is idle is based on the delay requirement indicated by the announcing signal and/or the delay requirement of the data transmission to be transmitted. Exemplarily, the backoff step may be set based on a principle that the stricter the delay requirement is, the larger the backoff step is, and/or the stricter the delay requirement of the data transmission to be transmitted is, the larger the backoff step is.

With the backoff procedure based on the delay requirement indicated by the announcing signal and/or the delay requirement of the data transmission to be transmitted of the second AP, the second AP with urgent traffic can obtain the bandwidth resource earlier, thereby facilitating the timely transmission of the urgent traffic.

Further, as stated above, the bandwidth resource to be shared may be or not be divided into multiple BWUs. In a case where the bandwidth resource to be shared is not divided into multiple BWUs, in the backoff procedure, the backoff counter is paused when the bandwidth resource is busy. In a case where the bandwidth resource to be shared is divided into multiple BWUs, in the backoff procedure, the backoff counter is paused only when all of the multiple BWUs are busy. In this way, the shared AP candidate (e.g., the second AP) can obtain at least one available BWU earlier, thereby facilitating the timely transmission of the traffic of the shared AP candidate.

In addition, in a case where the bandwidth resource to be shared is divided into multiple BWUs, when the second AP obtains the bandwidth resource (i.e., the success of contending for the bandwidth resource, causing a shared AP candidate to become a shared AP), the second AP can select a BWU including its primary channel to use in response to a determination that the multiple BWUs comprises the BWU including the primary channel. Alternatively, the second AP may select any one BWU of the multiple BWUs to use in response to a determination that the multiple BWUs does not comprise the BWU including its primary channel and it supports a dynamic sub-channel switch function (which may also be referred to as non-primary channel access function). Additionally, when the second AP obtains the bandwidth resource to be shared, the second AP can transmit a signal for setting a NAV timer associated with the selected BWU, to prevent other shared AP candidates from using the selected BWU. The signal for setting the NAV timer may include information on a duration for setting the NAV timer. Then, the shared AP candidates setting the NAV timer associated with the selected BWU do not contend for the selected BWU, before the NAV timer associated with the selected BWU expires. The shared AP candidates setting the NAV timer of the selected BWU can be able to contend for the selected BWU in response to a determination that the first time period does not end when the NAV timer associated with the selected BWU expires. For the remaining BWUs of the multiple BWUs excluding the selected BWU, they are available to be contended for by the shared AP candidates setting the NAV timer of the selected BWU, before the NAV timer associated with the selected BWU expires.

Moreover, in a case where the signal for announcing the bandwidth resource to be shared indicates a determined AP which is able to use the bandwidth resource during a second time period without contending, and the second time period, in response to a determination that the second AP is the determined AP, the second AP can use a part (e.g., in a case where the bandwidth resource to be shared is divided into a plurality of BWUs) or all (e.g., in a case where the bandwidth resource to be shared is not divided into the plurality of BWUs) of the bandwidth resource to be shared during the second time period without contending. During the second time period, other second APs which are not the determined AP indicated by the announcing signal can not contend for the bandwidth resource used by the second AP. The other second APs can contend for the remaining bandwidth resource of the bandwidth resource to be shared excluding the bandwidth resource used by the second AP. After the second time period, if the first time period does not end, the other APs can contend for the bandwidth resource used by the second AP.

Moreover, in a case where the announcing signal indicates a priority requirement for one or more APs receiving the announcing signal to determine whether to contend for the bandwidth resource, the second AP can contend for the bandwidth resource in response to a determination that a priority for its data transmission to be transmitted satisfies the priority requirement. That is, in a case where the announcing signal indicates the delay and priority requirements for the one or more APs receiving the announcing signal to determine whether to contend for the bandwidth resource, only shared AP candidates each having a data transmission with a delay requirement satisfying the delay requirement indicated by the announcing signal and a priority satisfying the priority requirement indicated by the signal can contend for the bandwidth resource to be shared. In addition, the backoff procedure can also be based on the priority requirement indicated by the announcing signal and/or the priority for the data transmission of the second to be transmitted. For example, the higher the priority requirement indicated by the announcing signal and/or the priority for the data transmission to be transmitted is, the smaller the initial value of the backoff counter of the backoff procedure is and/or the larger the backoff step is.

In the above, the methods (e.g., methods 200 and 800) for sharing the TXOP performed by the sharing AP (i.e., the first AP) and the shared AP candidate (i.e., the second AP) are described in connection with FIGS. 1-8. The method for sharing the TXOP performed by the sharing AP can indicate a delay requirement for one or more shared AP candidates to determine whether to contend for the bandwidth resource announced to be shared in a announcing signal, and accordingly the method for sharing the TXOP performed by the shared AP candidate can contend for the bandwidth resource announced to be shared based on the delay requirement indicated by the announcing signal, so that only shared AP candidates each having the data transmission satisfying the delay requirement indicated by the announcing signal can contend for bandwidth resource announced to be shared, which facilitates the timely transmission of the data transmission satisfying the delay requirement indicated by the announcing signal, thereby reducing the overall delay of the data transmission and improving the system performance of a communication system comprising several APs. In addition, the backoff procedure of the shared AP candidate for contending for the bandwidth resource announced to be shared can based on the delay requirement indicated by the announcing signal and/or the delay requirement of the data transmission to be transmitted of the shared AP candidate, thereby further facilitating the timely transmission of the data transmission. In the following, the disclosure will describe a communication device, for example an AP, according to an embodiment of the present disclosure.

FIG. 9 is a schematic block diagram of a communication device 900, for example an AP, according to an embodiment of the present disclosure. As shown in FIG. 9, the communication device 900 can comprise a circuit 910, and a transceiver 920. The communication device 900 can function as a sharing AP or a shared AP candidate. Exemplarily, when the communication device 900 functions as a sharing AP (i.e., the first AP), the circuit 910 may be configured to determine a bandwidth resource of a frequency band which is not to be used by the AP for a first time period of the TXOP of the frequency band, as described above according to embodiments in the disclosure. The transceiver 920 may be configured to transmit a signal for announcing the bandwidth resource not to be used by the sharing AP for the first time period, as described above according to embodiments in the disclosure. The signal indicates a delay requirement for one or more shared AP candidates (i.e., one or more second APs) to determine whether to contend for the bandwidth resource. Alternatively, the signal indicates one or more shared AP candidates and respective bandwidth resources allocated for the one or more shared AP candidates, and the one or more shared AP candidates can use the respective allocated bandwidth resources, e.g., to transmit data transmission.

When the communication device 900 functions as a shared AP candidate, the transceiver 920 may be configured to receive a signal for announcing a bandwidth resource not to be used by a sharing AP transmitting the signal for a first time period of the TXOP, as described above according to embodiments in the disclosure. The signal indicates a delay requirement for one or more shared AP candidates to determine whether to contend for the bandwidth resource. The circuit 910 may be configured to contend for the bandwidth resource in response to a determination that a delay requirement for a data transmission to be transmitted of the communication device 900 satisfies the delay requirement indicated by the signal, as described above according to embodiments in the disclosure. Alternatively, the signal indicates one or more shared AP candidates and respective bandwidth resources allocated for the one or more shared AP candidates. The communication device 900 can use the bandwidth resource allocated for it, e.g., to transmit data transmission.

In addition, the circuit 910 and/or the transceiver 920 may be further configured to perform other operations described above with reference to FIGS. 1-8, as long as there is no contradiction among these operations.

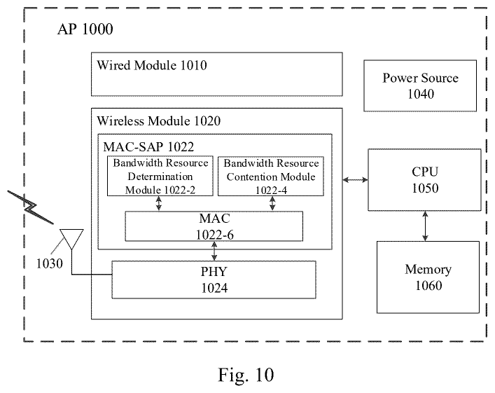

FIG. 10 shows an example configuration of a communication device 1000, for example an AP, according to an embodiment of the present disclosure. The communication device 1000 may include a wired module 1010, a wireless module 1020, at least one antenna 1030 (for the sake of simplicity, only one antenna is shown in FIG. 10), a power source 1040, a central processing unit (CPU) 1050 and at least one memory 1060. The wireless module 1020 may further comprise a MAC-SAP 1022 (i.e., the MAC sublayer) and PHY 1024 (i.e., the PHY sublayer). The MAC-SAP 1022 can comprise a bandwidth resource determination module 1022-2, a bandwidth resource contention module 1022-4, and MAC 1022-6. The bandwidth resource determination module 1022-2 can implement operations related to the bandwidth resource determination as described above, which is not repeated herein for brevity. The bandwidth resource contention module 1022-4 can implement operations related to the bandwidth resource contention as described above, which is not repeated herein for brevity.

The wireless module 1020 and the CPU 1050 may function together as a circuit of the communication device 1000 (e.g., the circuit 910 shown in FIG. 9), configured to perform related operations of methods (e.g., methods 200 and 800) as described in the present disclosure. In addition, it should be understood that although FIG. 10 shows the MAC-SAP comprises only one MAC, more than one MACs may be comprised in the MAC-SAP. The configuration of the communication device (e.g., AP) shown in FIG. 10 is merely an example, but not a limitation. The configuration of the communication device (e.g., AP) in the present disclosure can comprise more or fewer components than those in FIG. 10.

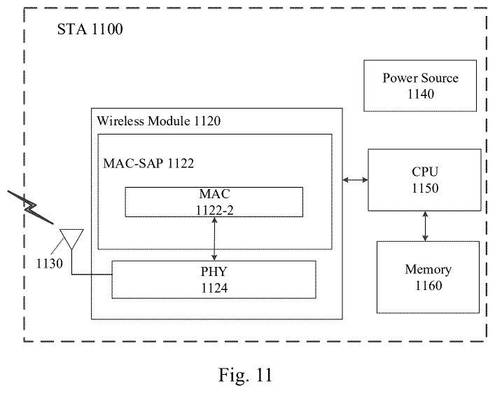

FIG. 11 shows an example configuration of a communication device 1100, for example terminal (such as a STA), according to an embodiment of the present disclosure. The communication device 1100 may include a wireless module 1120, at least one antenna 1130 (for the sake of simplicity, only one antenna is shown in FIG. 11), a power source 1140, a CPU 1150 and at least one memory 1160. The wireless module 1120 may further comprise a MAC-SAP 1122 (i.e., the MAC sublayer) at least including MAC 1122-2, and PHY 1124 (i.e., the PHY sublayer).

Similar to FIG. 10, it should be understood that although FIG. 11 shows the MAC-SAP comprises only one MAC, more than one MACs may be comprised in the MAC-SAP. The configuration of the communication device (e.g., STA) shown in FIG. 11 is merely an example, but not a limitation. The configuration of the communication device (e.g., STA) in the present disclosure can comprise more or fewer components than those in FIG. 11.

In addition, the present disclosure further provides a communication apparatus comprising means for the methods for sharing a TXOP (e.g., the methods 200 and 800) according to any embodiments of the present disclosure.

In addition, the present disclosure further provides a non-transitory computer readable storage medium storing a computer program thereon which, when being executed by a processor, implements the method for sharing a TXOP (e.g., the methods 200 and 800) according to any embodiment of the present disclosure.

In addition, the present disclosure further provides a computer program product storing instructions which, when being executed by a processor, implements the method for sharing a TXOP (e.g., the methods 200 and 800) according to any embodiment of the present disclosure.

So far, the present disclosure has disclosed methods for sharing a transmission opportunity (TXOP) performed by the sharing AP and the shared AP candidate, the communication device (e.g., AP) which can function as the sharing AP and the shared AP candidate, the communication apparatus which can function as the sharing AP and the shared AP candidate, the non-transitory computer readable storage medium and the computer program product for the method. The method for sharing the TXOP performed by the sharing AP, the device and the apparatus for the method can indicate a delay requirement for one or more shared AP candidates to determine whether to contend for the bandwidth resource to be shared in a announcing signal, and accordingly the method for sharing the TXOP performed by the shared AP candidate, the device and apparatus for the method can contend for the bandwidth resource to be shared based on the delay requirement indicated by the announcing signal, so that only shared AP candidates each having the data transmission satisfying the delay requirement indicated by the announcing signal can contend for bandwidth resource announced to be shared, which facilitate the timely transmission of the data transmission satisfying the delay requirement indicated by the announcing signal, thereby reducing the overall delay of the data transmission and improving the system performance of a communication system comprising several APs.

It should be noted that the above description is only some embodiments of the present disclosure and an illustration of the applied technical principles. It should be understood by those skilled in the art that the present disclosure scope involved in the present disclosure is not limited to the technical solutions resulted from specific combinations of the above technical features, but also encompasses other technical solutions resulted from any combination of the above technical features or their equivalents without departing from the above disclosed concept, for example, the technical solutions formed by replacing between the above features and the technical features with similar functions disclosed in the present disclosure (but not limited thereto).

In addition, although the operations are depicted in a specific order, this should not be understood as requiring these operations to be performed in the specific order shown or in a sequential order. In certain circumstances, multitasking and parallel processing may be beneficial. Likewise, although several specific implementation details are included in the above discussion, these should not be interpreted as limiting the scope of the present disclosure. Some features described in the context of separate embodiments can also be implemented in a single embodiment in combination. On the contrary, various features described in the context of a single embodiment can also be implemented in multiple embodiments alone or in any suitable sub-combination.

Although the subject matter has been described in a language specific to structural features and/or logical acts of methods, it should be understood that the subject matter defined in the appended claims is not necessarily limited to the specific features or acts described above. On the contrary, the specific features and actions described above are merely example forms of implementing the claims.

What is claimed is:

1. A method for sharing a transmission opportunity (TXOP) performed by a first access point (AP), comprising:
determining a bandwidth resource of a frequency band which is not to be used by the first AP for a first time period of the TXOP of the frequency band, and
transmitting a signal for announcing the bandwidth resource not to be used by the first AP for the first time period, wherein the signal indicates a delay requirement for one or more second APs to determine whether to contend for the bandwidth resource.

2. The method of claim 1, wherein the delay requirement comprises a delay limit, which indicates a maximum allowable delay for data transmission of an AP available to contend for the bandwidth resource among the one or more second APs.

3. The method of claim 1, further comprising:
determining an AP which is able to use the bandwidth resource for a second time period of the TXOP without contending,
wherein the second time period is shorter than or equal to the first time period, and wherein the signal further indicates the determined AP and the second time period.

4. The method of claim 1, wherein determining the bandwidth resource comprises:
determining the bandwidth resource based on at least one of a first bandwidth resource required by the first AP, a channel assessment by the first AP, a puncturing scheme associated with the frequency band, and a communication requirement associated with the one or more second APs.

5. The method of claim 4, wherein the communication requirement associated with the one or more second APs comprises at least one of: a requirement that the bandwidth resource covers primary channels of a maximum number of APs among the one or more second APs, a bandwidth resource requirement of the one or more second APs, or a delay requirement for data transmission of the one or more second APs.

6. The method of claim 5, wherein the bandwidth resource requirement of the one or more second APs is determined based on at least one of a first data amount of the one or more second APs buffered before a starting of the TXOP or a second data amount of the one or more second APs which is predicted to be arrived after the beginning of the TXOP.

7. The method of claim 4, wherein determining the bandwidth resource based on the first bandwidth resource, the channel assessment by the first AP, the puncturing scheme, and the communication requirement comprises:
determining a remaining bandwidth resource of the frequency band excluding the first bandwidth resource, based on the channel assessment by the first AP;
determining a second bandwidth resource of the remaining bandwidth resource that is available to be punctured, based on the puncturing scheme; and
determining the bandwidth resource based on the second bandwidth resource and the communication requirement.

8. The method of claim 1, wherein the bandwidth resource is divided into multiple bandwidth units (BWUs), and each of the multiple BWUs is indicated in the signal using a bandwidth of the BWU and a channel number of a channel included in the BWU.

9. The method of claim 1, further comprising:
reclaiming the bandwidth resource, in response to a determination that the bandwidth resource is not used by the one or more second APs for a third time period before an expiration of the first time period,
wherein the third time period is shorter than the first time period.

10. The method of claim 1, wherein the signal further indicates at least one of: the first time period, or a priority requirement for the one or more second APs to determine whether to contend for the bandwidth resource.

11. A method for sharing a transmission opportunity (TXOP) performed by a second access point (AP), comprising:
receiving a signal for announcing a bandwidth resource not to be used by a first AP transmitting the signal for a first time period of the TXOP, wherein the signal indicates a delay requirement for one or more APs receiving the signal which comprise the second AP to determine whether to contend for the bandwidth resource; and
contending for the bandwidth resource in response to a determination that a delay requirement for a data transmission to be transmitted of the second AP satisfies the delay requirement indicated by the signal.

12. The method of claim 11, wherein the delay requirement comprises a delay limit, and wherein contending for the bandwidth resource comprising contending for the bandwidth resource in response to a determination that a maximum allowable delay for the data transmission to be transmitted of the second AP is lower than the delay limit.

13. The method of claim 11, wherein contending for the bandwidth resource comprises:
contending for the bandwidth resource based on a backoff procedure, wherein the backoff procedure is based on at least one of the delay requirement indicated by the signal or the delay requirement for the data transmission to be transmitted of the second AP.

14. The method of claim 13, wherein the bandwidth resource is divided into multiple bandwidth units (BWUs), wherein each of the multiple BWUs is indicated in the signal using a bandwidth of the BWU and a channel number of a channel included in the BWU, and wherein a backoff counter of the backoff procedure is paused only when all of the multiple BWUs are busy.

15. The method of claim 14, the method further comprising:
in response to a success of contending for the bandwidth resource:
selecting a BWU including a primary channel of the second AP to use in response to the multiple BWUs comprising the BWU including the primary channel of the second AP; and
selecting any one BWU of the multiple BWUs to use in response to the multiple BWUs not comprising the BWU including the primary channel of the second AP and the second AP supporting a dynamic sub-channel switch function or a non-primary channel access function.

16. The method of claim 15, further comprising:
transmitting a signal for setting a network allocation vector (NAV) timer associated with the selected BWU,
wherein the signal for setting the NAV timer indicates a duration for setting the NAV timer, and
wherein APs of the one or more APs receiving the signal for setting the NAV timer do not contend for the selected BWU, before an expiration of the NAV timer associated with the selected BWU.

17. The method of claim 16, wherein remaining BWUs of the multiple BWUs excluding the selected BWU are available to be contended for by the APs receiving the signal for setting the NAV timer, before the expiration of the NAV timer associated with the selected BWU.

18. The method of claim 11, wherein the signal further indicates a determined AP which is able to use a part or all of the bandwidth resource for a second time period without contending and the second time period, and wherein the second time period is shorter than or equal to the first time period, the method further comprising:
using the part or all of the bandwidth resource during the second time period without contending, in response to the second AP being the determined AP.

19. The method of claim 11, wherein the signal further indicates at least one of: the first time period, or a priority requirement for the one or more APs to determine whether to contend for the bandwidth resource, and
wherein contending for the bandwidth resource further comprising contending for the bandwidth resource in response to a determination that a priority for the data transmission to be transmitted of the second AP satisfies the priority requirement.

20. A method for sharing a transmission opportunity (TXOP) performed by a first access point (AP), comprising:
determining a bandwidth resource of a frequency band which is not to be used by the first AP for a first time period of the TXOP of the frequency band, and
transmitting a signal for announcing the bandwidth resource not to be used by the first AP for the first time period, wherein the signal indicates one or more second APs and respective bandwidth resources allocated for the one or more second APs, and wherein the one or more second APs use the respective allocated bandwidth resources during the first time period.
